(19) United States
(12) Patent Application Publication
(10) Pub. No.: US 2008/0202614 A1
(43) Pub. Date: Aug. 28, 2008

(54) Passage block and manufacturing method thereof

(75) Inventors: Mitsuru Mamyo, Nagoya-shi (JP); Kazutoshi Itoh, Kani-shi (JP)

Correspondence Address: OLIFF & BERRIDGE, PLC, P.O. BOX 320850, ALEXANDRIA, VA, 22320-4850, US

(73) Assignee: CKD CORPORATION, KOMAKI-SHI (JP)

(21) Appl. No.: 12/003,918

(22) Filed: Jan. 3, 2008

(30) Foreign Application Priority Data
Feb. 26, 2007 (JP) 2007-045575

(51) Int. Cl. F16K 1/00; B23K 1/20

(52) U.S. Cl. 137/884; 29/890.12

(57) ABSTRACT

A passage block formed with a passage connectable to a fluid control device comprises a first block member formed with a plurality of first-coupling-face apertures, a second block member formed with a plurality of second-coupling-face apertures in correspondence with the first-bonding-apertures, a first passage-end contact portion formed around each of the first-coupling-face apertures, a second passage-end contact portion formed around each of the second-coupling-face apertures, and a passage-end contact section provided in such a manner that a lower surface of the first block member and an upper surface of the second block member are arranged to face each other so that the first and second passage-end contact portions contact with each other, and the first and second block members are heated under pressure to diffusion-bond the first and second passage-end contact portions to each other.

### BACKGROUND OF THE INVENTION

1. Field of the Invention

The present invention relates to a passage block having a complicated passage, which is used in a process gas supply unit, and a manufacturing method of the passage block.

2. Description of Related Art

A process gas supply unit to be used in a semiconductor manufacturing process includes a passage block made of a high-corrosion-resistant stainless block formed with a passage.

This passage is conventionally formed in the passage block by machining. However, most of the passages formed by this technique are simple in shape because the machining requires a space enough for a cutting tool such as an end mill and a drill to enter, thus inevitably resulting in a combined form of straight shapes.

In the case of forming a passage of complicated shape in a passage block, it is necessary to process a plurality of separate blocks respectively and then couple them by welding or bolts.

As an example of the complicated passage, there is a case of forming a U-shaped passage in a passage block. In this case, complex procedures as disclosed in JP2003-97752A for example would be performed to form the passage.

FIG. 24 shows a perspective view of a passage block in the process of forming the U-shaped passage. This is assumed as a first processing step. FIG. 25 shows a sectional view of the passage block in a second processing step; FIG. 26 shows another sectional view of the passage block in a third processing step; and FIG. 27 shows another sectional view of the passage block in a fourth processing step.

A passage block 201 is provided with a U-shaped passage. The processing steps (hereinafter, simply referred to as “step”) shown in FIGS. 24 to 27 are explained below.

In the first step, as shown in FIG. 24, a first open passage 221 is formed in a block body 211 from above and an auxiliary passage 223 and a communication passage 222 are formed from side so as to communicate with a lower end of the first open passage 221. At that time, a large-diameter recess 225 is formed in a side surface to facilitate subsequent steps.

In the second step, as shown in FIG. 25, a thin-disk-shaped block member 224 is inserted in the communication passage 222.

In the third step, as shown in FIG. 26, the block member 224 is welded to the auxiliary passage 223, forming a welded portion W.

In the fourth step, as shown in FIG. 27, a second open passage 226 is formed by cutting away the block member 224 and part of the welded portion W.

The above process of producing the passage block 201 would cause a problem that the length of the communication passage 222 is restricted by the processing limit of the tool in the first step of forming the communication passage 222 and the auxiliary passage 223.

In other words, to form a passage such as the communication passage 222, a deep hole is formed in the block body 211 from side with a drill. For a deeper hole, a cooling efficiency during processing is apt to decrease, causing baking or other defects. A hole deeper than a predetermined depth would be hard to form. As stated, the passage shape has a limitation according to processing tools and it is therefore hard to form complicated passages in the passage block 201.

To solve the above problems, for example, a method disclosed in JP2006-84002A has been proposed.

JP2006-84002A discloses an invention related to a passage block including a block body and a lid member. The passage block is formed with a complicated passage in such a way that grooves which will constitute a passage are formed in the block body by a cutting work and then the lid is welded to the block body.

FIG. 28 is a perspective view of the passage block in JP2006-84002A.

A passage block 101 is composed of a block body 111 and a lid member 112. In the block body 111, a through hole 121 and a groove 122 are formed, and a groove 122a is formed to receive the lid member 112 in parallel with the groove 122. The lid member 112 is made of an oval plate material which is fitted and welded in the groove 122a of the block body 111, thereby forming a passage.

Since the groove 122 is formed in the block body 111 with a cutting tool, a passage can be formed with a relatively high degree of freedom.

The technique disclosed in JP2006-84002A could provide the complicated passage with ease. However, a problem occurs that a stagnation region is generated in the passage.

The process gas supply unit to be used in the semiconductor manufacturing process may be employed to flow corrosive gas that tends to crystallize. However, in the configuration as shown in JP2006-84002A, the block body 111 is provided, around a passage forming portion, with the groove 122a which receives the lid member 112 and the lid member 112 is welded to the block body 111. Thus, the lid member 112 constitutes part of the passage, resulting in a square-cornered boundary between of the block body 111 and the lid member 112. Such a square outer corner of the passage is likely to cause fluid stagnation.

Such a stagnation region causes fluid stagnation when a fluid allowed to flow in the passage is changed to another or is purged to clean the passage. This stagnated fluid would interfere with fluid replacement. In the case where the fluid allowed to flow is a gas tending to crystallize, it may crystallize in the stagnation region.

If the fluid crystallizes in the stagnation region, the flow of purge gas used for purging the passage will weaken in the fluid stagnation region and thus cannot easily blow away resultant crystals.

In the case of a corrosive fluid, the purity of fluid increases when crystallizes, which conceivably causes a problem that it erodes the block body 111 and the lid member 112. In particular, when a gap occurs between the block body 111 and the lid member 112 due to a bonding failure, undesirably, purging would be more difficult.

### BRIEF SUMMARY OF THE INVENTION

The present invention has been made in view of the above circumstances and has an object to provide a passage block capable of providing a complicated passage which is unlikely to produce a stagnation region.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a passage block connectable to a fluid control device for controlling a fluid, the passage block being formed with a passage connectable to the fluid control device, the passage block comprising: a first block member including a first coupling face and a plurality of first-coupling-face apertures opening in the first coupling face; a second block member including a second coupling face and a plurality of second-coupling-face apertures opening in the second coupling face in correspondence with the first-coupling-face apertures; a passage-end contact section including: a first passage-end contact portion formed around each of the first-coupling-face apertures; and a second passage-end contact portion formed around each of the second-coupling-face apertures; the passage-end contact portion being provided in such a manner that the first coupling face of the first block member and the second coupling face of the second block member are arranged to face each other so that the first passage-end contact portion and the second passage-end contact portion contact with each other, the first and second block members are heated under pressure in a direction perpendicular to the first and second coupling faces to diffusion-bond the first and second passage-end contact portions to each other.

As above, the passage block includes the passage-end contact section formed by the first and second passage-end contact portions diffusion-bonded to each other. Accordingly, the passage block with complicated passages can be provided in such a way that the first and second block members are formed with the passages respectively by machining or other techniques and then bonded to each other.

The diffusion bonding is performed by placing surfaces in contact with each other and heating them under pressure. To provide passages in the bonded first and second block members, therefore, the first and second coupling faces have to be bonded to each other without gaps therebetween to prevent fluid leakage. In this regard, the first and second passage-end contact portions are diffusion-bonded in contact with the other, providing smaller contact areas than the case where the first and second coupling faces are bonded to each other over the entire surfaces. Thus, the processing accuracy can be enhanced to prevent the occurrence of fluid leakage.

Since the first and second block members are bonded to each other by diffusion bonding, there is no need to prepare a lid member as disclosed in JP2006-84002A for each passage. To provide a U-shaped passage, for example, the first block member is formed with a through hole and the second block member is formed with a straight passage. The straight passage of the second block member is further machined to round out each corner. Thus, the passage block can provide the U-shaped passage having the rounded outer corner, not square corner.

The contact portions around the passages of the blocks are diffusion-bonded to each other as above, so that the passage block unlikely to generate stagnation region in each passage.

Preferably, the above passage block further comprises: a first coupling protrusion formed to protrude from the first coupling face around the first-coupling-face aperture and include the first passage-end contact portion; and a second coupling protrusion formed to protrude from the second coupling face around the second-coupling-face aperture and include the second passage-end contact portion. This makes it possible to reduce a surface area to be finish-processed (hereinafter, a “finish processing area”), which is required for diffusion bonding, and easily ensure the necessary surface accuracy. As the finish processing area is larger, processing irregularity may occur, leading to bonding failure. However, the reduction in finish processing area needed for bonding can decrease the possibility of bonding failure.

The force required for pressing the first and second block members also can be lowered owing to the reduction in bonding area. This can contribute to downsizing of a pressure device.

Further, in any one of the aforementioned passage blocks, preferably, one of the first-coupling-face aperture and the second-coupling-face aperture is on the upstream side and the other is on the downstream side, and the aperture area on the downstream side is smaller than that on the upstream side. It is therefore possible to absorb a processing dimensional tolerance of the first and second coupling-face apertures.

When the first and second block members are individually processed as separate components of a passage block, a dimensional tolerance is apt to occur. Such dimensional tolerance may lead to a factor that produces a shoulder in the passage when the first and second coupling-face apertures are bonded to each other. To ensure the necessary diameter of the passage, the diameter of the downstream passage having a smaller aperture area has to be determined to be the minimum passage diameter and the diameter of the upstream passage is determined to correspond to the dimensional tolerance. Even if the tolerance occurs, therefore, the necessary passage diameter can be ensured.

If the shoulder includes a sharply enlarged portion with respect to the passage, such the portion may become a fluid stagnation region. Some passage blocks provided in a gas supply integrated unit used in a semiconductor manufacturing process are allowed to flow therein corrosive gas tending to crystallize. It is therefore conceivable that the gas crystallized and hence condensed erodes the passage block. Under the circumstances, such stagnation region needs to be eliminated as much as possible.

Since the aperture area on the downstream side is smaller than the aperture area on the upstream side, the crystallized gas even when formed in the shoulder can be eliminated advantageously.

Preferably, the passage block further comprises a gasket interposed between the first and second block members to couple the first-coupling-face aperture and the second-coupling-face aperture, and wherein the first passage-end contact portion and the second passage-end contact portion are placed in contact with the gasket respectively and diffusion-bonded to each other to form the passage-end contact section. Accordingly, the bonding faces of the gasket and the first and second passage-end contact portions are finish-processed and diffusion-bonded to each other. Consequently, the finish area can be reduced, and the pressure required for pressing can be reduced, contributing to downsizing of a pressure device.

Preferably, the gasket is formed with an inner passage that has an aperture area on an upstream side being smaller than an aperture area on a downstream side.

Accordingly, the area of an upstream-side aperture of the gasket is smaller than the area of the first-coupling-face aperture and the area of the second-coupling-face aperture is smaller than the area of a downstream-side aperture of the gasket. Thus, the areas of the apertures in respective coupling portions are always larger on the upstream side than on the downstream side, which can prevent the occurrence of a fluid stagnation region in the passage.

According to another aspect, the present invention provides a method of manufacturing a passage block connectable to a fluid control device for controlling a fluid, the passage block being formed with a passage connectable to the fluid control device, the method comprising the steps of: arranging a first block member including a first coupling face and a plurality of first-coupling-face apertures opening in the first coupling face and a second block member including a second coupling face and a plurality of second-coupling-face apertures opening in the second coupling face in correspondence with the first-coupling-face apertures so that a first passage-end contact portion formed around each of the first-coupling-face apertures is placed in contact with a second passage-end contact portion formed around each of the second-coupling-face apertures; pressing the first and second block members by use of a block pressure device; and heating the first and second block members by use of a heating device to diffusion bond the first passage-end contact portion and the second passage-end contact portion to form the passage.

According to the above manufacturing method, the first and second block members are diffusion-bonded through respective contact portions around the passage, so that the passage block can be provided with complicated passages which are unlikely to have stagnation regions.

Preferably, the above method of manufacturing the passage block, further comprises the steps of: interposing a gasket between the first block member and the second block member to couple the first-coupling-face aperture and the second-coupling-face aperture; and positioning the gasket in place by use of a gasket holding member for holding the gasket so that the gasket is diffusion-bonded to the first and second block members. It is therefore possible to easily position the gasket in place and form the passage without displacement when the first and second block members are bonded to each other.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a sectional view of a passage block of a first embodiment of the present invention;

FIG. 2 is a top view of a first block member of the first embodiment;

FIG. 3 is a sectional view of the first block member of the first embodiment;

FIG. 4 is a top view of a second block member of the first embodiment;

FIG. 5 is a sectional view of the second block member of the first embodiment;

FIG. 6 is a top view of a gasket of the first embodiment;

FIG. 7 is a sectional view of the gasket of the first embodiment;

FIG. 8 is a top view of a retainer of the first embodiment;

FIG. 9 is a sectional view of the retainer of the first embodiment;

FIG. 10 is a sectional view of an assembly of the first block member, second block member, and gasket of the first embodiment;

FIG. 11 is an exploded perspective partial view of the first block member, second block member, and gasket to be assembled in the first embodiment;

FIG. 12 is an exploded perspective partial view of a first block member and a second block member to be assembled in a second embodiment;

FIG. 13 shows, as a comparative example to a third embodiment of the present invention, a state before a lower surface of the first block and an upper surface of the second block are placed in contact with each other for diffusion bonding;

FIG. 14 shows, as the comparative example to a third embodiment of the present invention, a state where the lower surface of the first block and the upper surface of the second block are placed in contact with each other for diffusion bonding;

FIG. 15 is an enlarged view showing a shoulder portion produced by the diffusion bonding, as the comparative example to a third embodiment of the present invention;

FIG. 16 shows a state before a lower surface of the first block and an upper surface of the second block are placed in contact with each other for diffusion bonding in the third embodiment;

FIG. 17 shows a state where the lower surface of the first block and the upper surface of the second block are placed in contact with each other for diffusion bonding in the third embodiment;

FIG. 18 is an enlarged view showing a shoulder portion produced by the diffusion bonding in the third embodiment;

FIG. 19 shows a state before a first block member, a second block member, and a gasket are placed in contact with each other for diffusion bonding in a fourth embodiment;

FIG. 20 shows a state where the first block member, the second block member, and the gasket are placed in contact with each other in the fourth embodiment;

FIG. 21 is an enlarged view showing a shoulder portion produced by the diffusion bonding in the fourth embodiment;

FIG. 22 is a sectional view of a passage block made of a plurality of block members in a comparative example to a fifth embodiment of the present invention;

FIG. 23 is a sectional view showing a case where the passage block assembled by diffusion-bonding the plurality of block members with a through-type gasket in the fifth embodiment;

FIG. 24 is a perspective view of a passage block in a first processing step of forming a U-shaped passage in a prior art, JP2003-97752A;

FIG. 25 is a sectional view of the passage block in a second processing step in the prior art, JP2003-97752A;

FIG. 26 is a sectional view of the passage block in a third processing step in the prior art, JP2003-97752A;

FIG. 27 is a sectional view of the passage block in a fourth processing step in the prior art, JP2003-97752A; and

FIG. 28 is a perspective view of a passage block in another prior art, JP2006-84002A.

### DETAILED DESCRIPTION OF THE PREFERRED EMBODIMENTS

A detailed description of a preferred embodiment of a passage block embodying the present invention will now be given referring to the accompanying drawings.

### First Embodiment

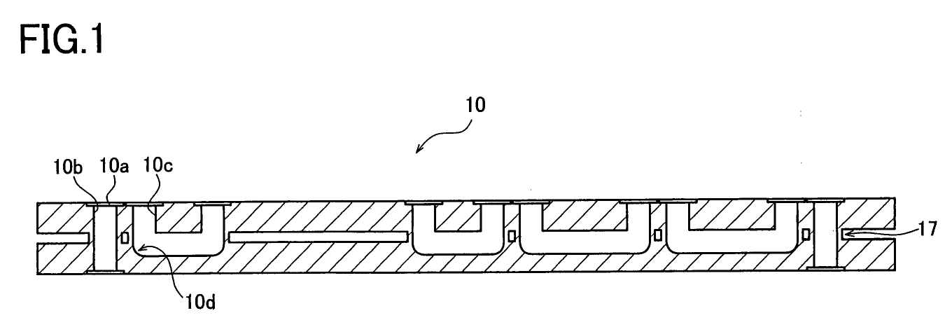

A configuration of a first embodiment of the present invention is first explained below. FIG. 1 is a sectional view of a passage block of the first embodiment.

A passage block 10 is usable in a gas integrated unit for use in a semiconductor manufacturing step. On its top surface, fluid control devices not shown for control of gas or the like are mountable and usable in the gas integrated unit.

The passage block 10 is provided with a plurality of counter bores 10a for gasket, straight passages 10b, and U-shaped passages 10c. Each counter bore 10a holds a gasket not shown through which a fluid control device is to be mounted on the passage block 10. The passage block 10 includes an upper part and a lower part which are diffusion-bonded by a passage-end contact section 17 that joins them as shown in FIG. 1.

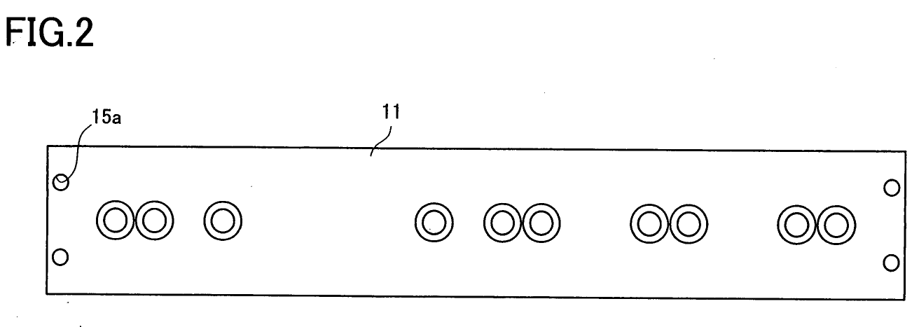

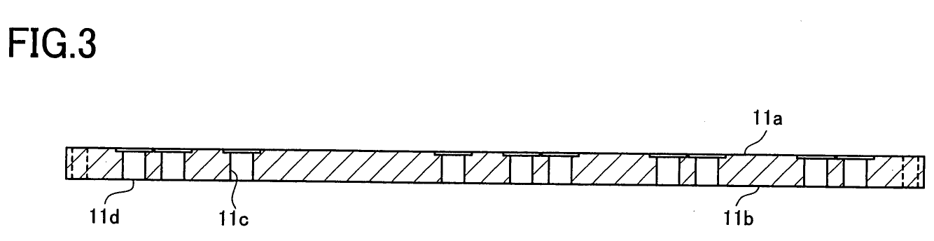

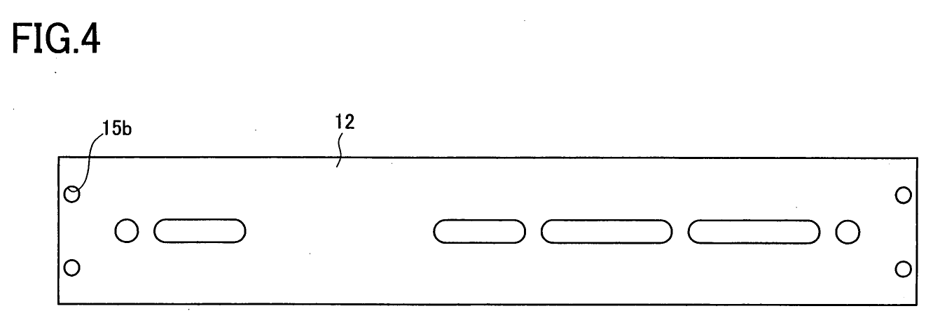

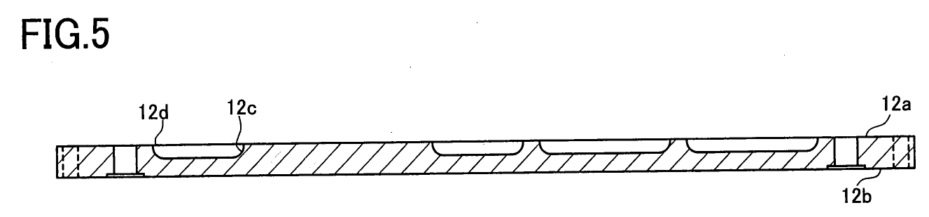

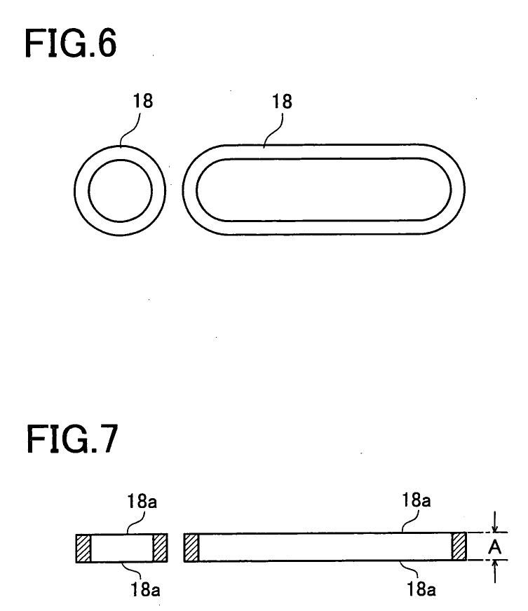

FIG. 2 is a top view of a first block member 11 constituting the passage block 10 shown in FIG. 1. FIG. 3 is a sectional view of the first block member 11. FIG. 4 is a top view of a second block member 12 constituting the passage block 10 shown in FIG. 1. FIG. 5 is a sectional view of the second block member 12. FIG. 6 is a top view of a gasket 18 for coupling the first block member 11 and the second block member 12 constituting the passage block 10. FIG. 7 is a sectional view of the gasket 18.

The passage block 10 includes the first block member 11 and the second block member 12 which are coupled by the gasket 18.

The first block member 11 is provided with a first-block upper surface 11a and a first-block lower surface (a first coupling face) 11b and formed with a plurality of upper passages 11c each forming an upper part of a straight passage 10b or a U-shaped passage 10c. In the first embodiment, ten upper passages 11c are provided. Each upper passage 11c has a first-coupling-face aperture 11d opening in the lower surface 11b. The first block member 11 is provided with first positioning pin holes 15a at four corners as shown in FIG. 2.

The second block member 12 is provided with a second-block upper surface (a second coupling face) 12a and a second-block lower surface 12b and formed with a plurality of lower passages 12c each forming a lower part of the straight passage 10b or U-shaped passage 10c. In the first embodiment, two vertical passages and four horizontal passages are provided. Each lower passage 12c has a second-coupling-face aperture 12d opening in the upper surface 12a. The second block member 12 is provided with second positioning pin holes 15b at four corners as shown in FIG. 4.

Those first and second block members 11 and 12 are made of a stainless material such as SUS316L by machining. The gas integrated unit may be used for control of high corrosive gas. It is therefore preferable to select a high-corrosion-resistant material according to purposes.

The gasket 18 is formed of a cylindrical shape or an oval cylindrical shape, having a thickness of a few millimeters. The material of the gasket 18 may be SUS316L the same as the first and second block members 11 and 12 or a higher-corrosion-resistant material such as HASTELLOY®. The thickness of the gasket 18 is assumed as “A” in FIG. 7. Each end face of the gasket 18 is referred to as a gasket end face 18a for convenience of explanation.

The above first block member 11, second block member 12, and gasket 18 are bonded to form the passage block 10 shown in FIG. 1. For performing diffusion bonding, respective coupling faces, namely, the lower surface 11b of the first block 11 and one end face 18a of the gasket 18, and, the other end face 18a of the gasket 18 and the upper surface 12a of the second block member 12 have to be placed in uniform contact with each other over the entire areas of the gasket end faces 18a.

Accordingly, a portion around the first-coupling-face aperture 11d of the first-block lower surface 11b, a portion around the second-coupling-face aperture 12d of the second-block lower surface 12b, and the gasket end faces 18a have to be formed with good surface roughness by lap-grinding or other techniques to ensure flatness thereof.

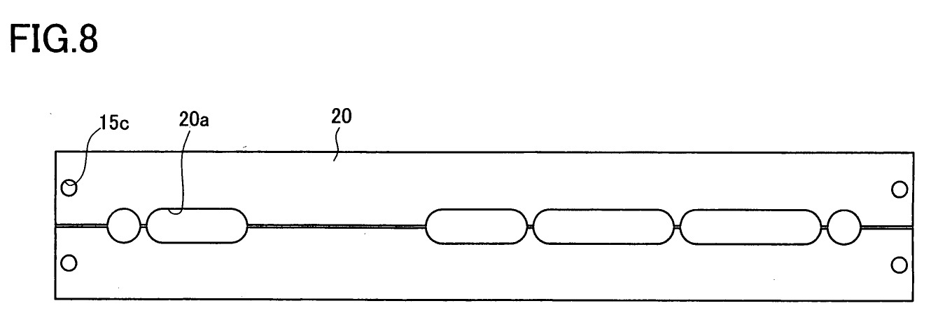

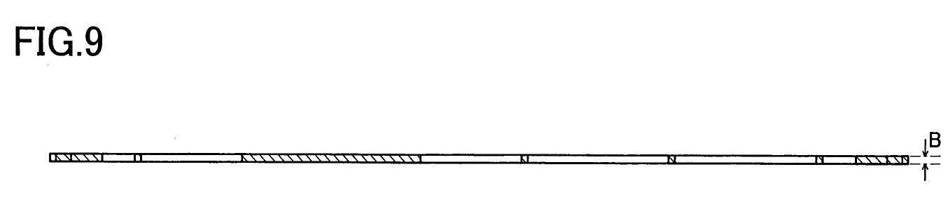

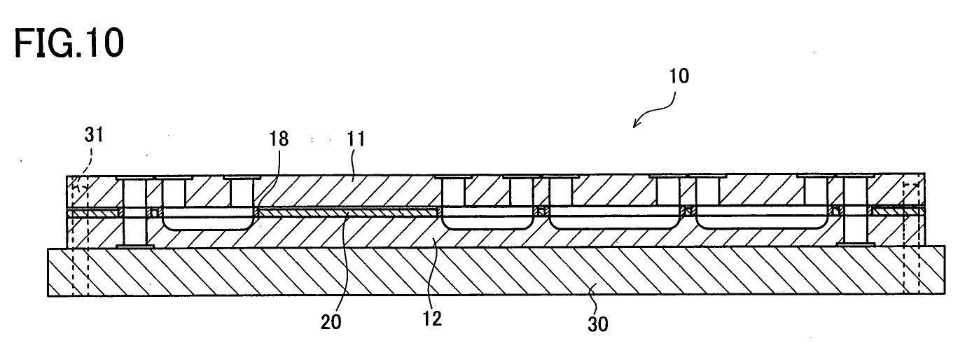

The structure of the passage block 10 in the first embodiment will be described below. FIG. 8 is a top view of a retainer 20 to be used for assembling the passage block 10. FIG. 9 is a sectional view of the retainer 20. FIG. 10 is a sectional view of an assembly of the first block member 11, the second block member 12, and the gasket 18 to constitute the passage block 10.

The retainer 20 serving as a gasket holding member is composed of two parts separable along a central axis. The retainer 20 is designed to have a thickness “B” as shown in FIG. 9, which is thinner than the gasket thickness “A”. The material of the retainer 20 may be any materials if only having rigidity enough to hold the gasket 18 and resistance to heat during diffusion bonding. In the present embodiment, it is the same material as that of the first block member 11 and others.

The retainer 20 is provided with gasket holding portions 20a arranged along the central axis. The retainer 20 is further provided with third positioning pin holes 15c at four corners. A positioning jig 30 includes positioning pins 31 at four corners.

For assembling of the passage block 10, the second block member 12 is first set in the positioning jig 30 so that the second positioning pin holes 15b at four corners of the second block member 12 are aligned with the positioning pins 31 of the positioning jig 30. Then, the retainer 20 is similarly disposed so that the third positioning pin holes 15c of the retainer 20 are aligned with the positioning pins 31 of the positioning jig 30. The gaskets 18 are then fitted in the corresponding gasket holding portions 20a of the retainer 20. Finally, the first block member 11 is disposed so that the first positioning pin holes 15a at four corners of the first block member 11 are aligned with the positioning pins 31 of the positioning jig 30.

The first block member 11, second block member 12, and retainer 20 are disposed as above so that the first positioning pins 15a, second positioning pins 15b, and third positioning pins 15c are aligned with the positioning pins 31 of the positioning jig 30. Thus, the gasket 18 is located in place by the retainer 20. The first block member 11 and the second block member 12 are also located in appropriate places.

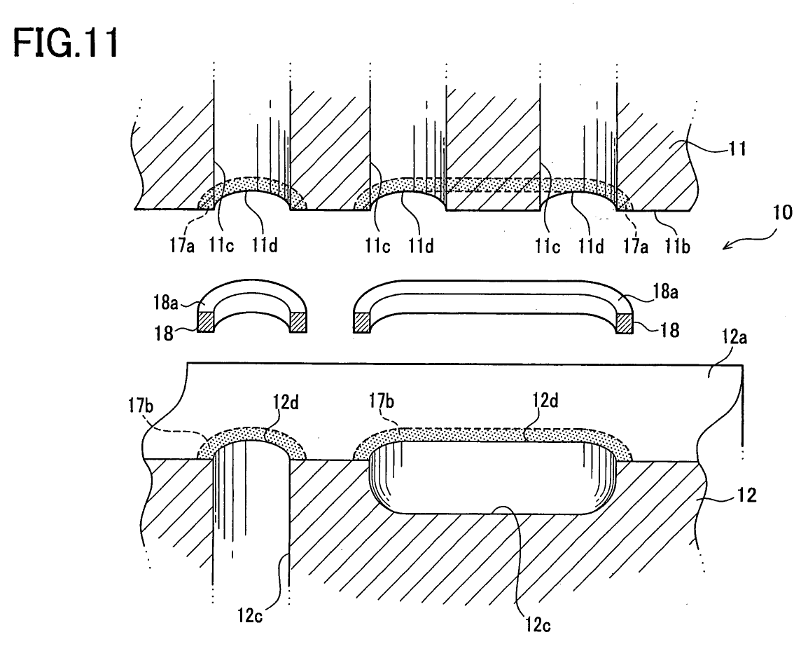

FIG. 11 is an exploded perspective partial view of the first block member 11, second block member 12, and gasket 18, showing respective bonding states.

The first and second block members 11 and 12 are diffusion-bonded to each other through the gaskets 18, thereby joining the upper passages 11c of the first block member 11 and the lower passages 12c of the second block member 12 via the gaskets 18 to form the straight passages 10b or U-shaped passages 10c as shown in FIG. 1.

At that time, a first passage-end contact portion 17a around the first-coupling-face aperture 11d of the first block member 11 and a second passage-end contact portion 17b around the second-coupling-face aperture 12d of the second block member 12 are placed in contact with the end faces 18a of the gasket 18 respectively. Thus, the first block member 11, the second block member 12, and each gasket 18 are in contact with each other through respective surfaces.

Thereafter, the passage block 10 is put in a heating machine and heated while being pressed from above and below by a pressure device. A required pressure force is about several tens of kg/cm². When the passage block 10 is heated under pressure, the contact portions 17a and 17b are diffusion-bonded to the contact portions of the gasket end faces 18a, thereby forming the passage block 10 including the first block member 11, second block member 12, and gasket 18 which are integrally assembled.

After the passage block 10 is taken out of the heating machine, the positioning jig 30 is detached from the passage block 10 and then the retainer 20 is removed. The retainer 20 which has a two-separable configuration can be easily removed after detachment of the positioning jig 30.

In the passage block 10 configured as above with a clearance provided around each gasket 18, the gasket end faces 18a are diffusion-bonded to the contact portions 17a and 17b respectively, bonding the areas surrounding the passages, to form a passage-end contact section 17. The clearance may be filled with resin or the like or may be used as a space for installation of a heater member, for example.

The advantages of the first passage block 10 of the first embodiment will be explained below.

A first advantage is the configuration that the first and second block members 11 and 12 are bonded to each other through the gaskets 18, so that a complicated passage can be provided in the passage block 10.

The lower passage 12c of the second block member 12 can be formed in the shape of a groove by use of a machine tool such as an end mill.

When a passage is to be formed in a stainless steel block by machining to provide the passage block 10 according to the technique as disclosed in JP2003-97752A, such a U-shaped passage 10c is likely to be limited in depth due to the limit on the cutting tool as mentioned above.

In the case of the passage block 10 of the first embodiment, on the other hand, the U-shaped passage 10c having a necessary length can be formed by machining the second block member 12 constituting the passage block 10 from the side of the upper surface 12a with a tool such as an end mill to form the lower passage 12c. A plurality of such U-shaped passages 10c could not easily be provided in line as in the passage block 10 by the method disclosed in JP2003-97752A, whereas it can be easily formed by the method disclosed in the first embodiment of the invention.

Accordingly, the straight passages 10b and the U-shaped passages 10c can be configured with a relatively free pattern in the passage block 10.

The application of the process of diffusion-bonding the first and second block members 11 and 12, which does not need the welding mentioned in JP2006-84002A, makes it possible to form complicated passages that could not be machined unless a passage block is divided into three or more parts.

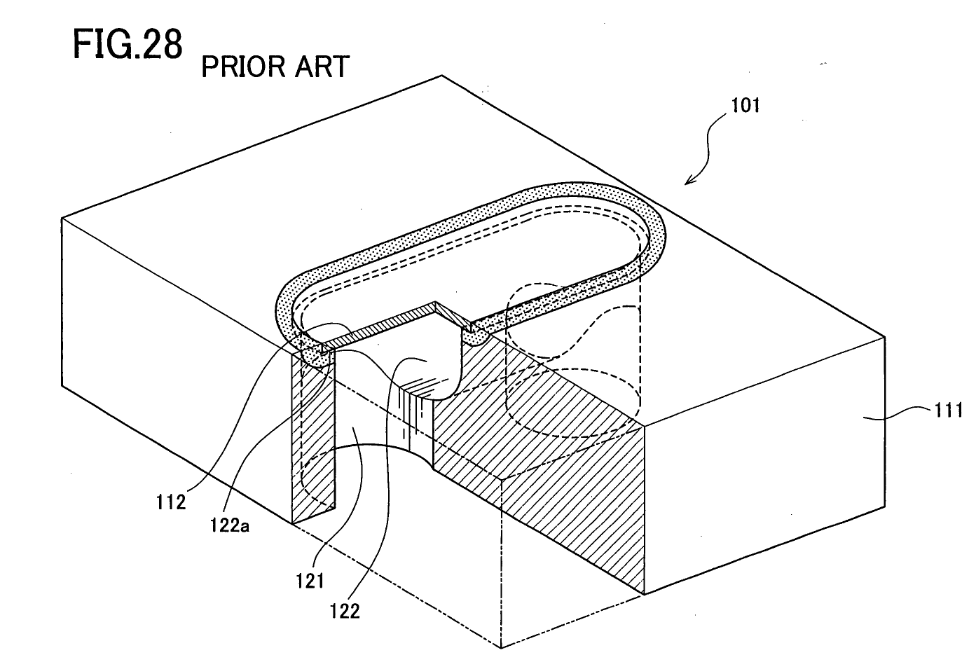

A second advantage is to provide a passage with less stagnation region. The passage of the first embodiment is subjected to a process of rounding out each corner 10d of the U-shaped passage 10c shown in FIG. 1. Accordingly, the passage can be configured with less stagnation region. By the method disclosed in JP2006-84002A, on the other hand, the U-shaped passage is provided with a square corner as shown in FIG. 28. By the method disclosed in JP2003-97752A, similarly, the U-shaped passage is likely to include a pocket as part of a corner as shown in FIG. 27. Both cases are likely to cause stagnation regions.

In the case where the gas integrated unit provided with the passage block 10 is supplied with fluid and then with different fluid for replacement, the fluid replacement is hard to achieve in the above stagnation regions in the passages. It is therefore predicted that a slight amount of gas remaining in the stagnation region is mixed with replacement gas. When a gas tending to crystallize is caused to flow, it is likely to crystallize in the stagnation region. Such crystallized gas in the stagnation region is hard to purge.

According to the method described in the first embodiment, the passage block 10 with less stagnation region can be provided, resulting in a reduction of the factors that cause crystallization of supplied fluid, mixture of gas, and others.

A third advantage is a reduction in area needed to be lap-ground because the first and second block members 11 and 12 are diffusion-bonded to each gasket 18.

For diffusion bonding of the surfaces, the surfaces have to be placed in contact with each other with minimum gap therebetween. This is because the diffusion bonding is a method of bonding interfaces in close contact with each other under high temperature and high pressure by utilizing a phenomenon that atoms in each interface diffuse along grain boundary and combine with each other.

Thus, the exchange of atoms is not performed in gap portions of the surfaces, so that the surfaces cannot bond to each other. To avoid this defect, it is necessary to place the first passage-end contact portion 17a of the first block member 11 and the end face 18a of the gasket 18 in close contact relation and also place the second passage-end contact portion 17b of the second block member 12 and the other end face 18a of the gasket 18 in close contact relation during bonding.

To ensure the contact between the surfaces, the first passage-end contact portion 17a, the second passage-end contact portion 17b, and the gasket end faces 18a are subjected to a lap-grinding work after a normal cutting work.

The lap-grinding is a method performed by placing a tool in contact with a surface to be processed using grinding solution, and grinding the surface while vibrating it. This work requires time and cannot ensure processing accuracy such as flatness for a wider area.

Consequently, it is preferable to perform diffusion bonding in the passage-end contact section 17 which is the most necessary to be bonded to form a passage in the first and second block members 11 and 12 bonded through the gaskets 18 as compared with the case where the first and second block members 11 and 12 are directly bonded to each other.

Specifically, the portion that needs to be lap-ground is the gasket end faces 18a and the first and second passage-end contact portions 17a and 17b. The processing time can be shortened than that for the uniform processing of the entire surfaces and the processing accuracy can be enhanced.

A fourth advantage is a reduction in the force required for pressing the first and second block members 11 and 12, because they are bonded to each other through the passage-end contact section 17. Thus, a smaller pressure device is usable.

The diffusion bonding requires a force above a certain level per unit area. As a reduction in bonding area, the force required for pressing can be reduced. Such reduction in pressure force allows a reduction in the size of a pressure device. Generally, a hydraulic device or the like has to be used to generate a pressure force. In any manner, however, the size of pressure device is increased in proportion to the needed pressure force. A larger device leads to an increase in initial cost and running cost. Therefore, a smaller device is preferable.

### Second Embodiment

A second embodiment is similar in structure to the first embodiment excepting a coupling structure of the first and second block members 11 and 12. The following explanation is made with a focus on the differences. Similar components to those in the first embodiment are given the same reference codes.

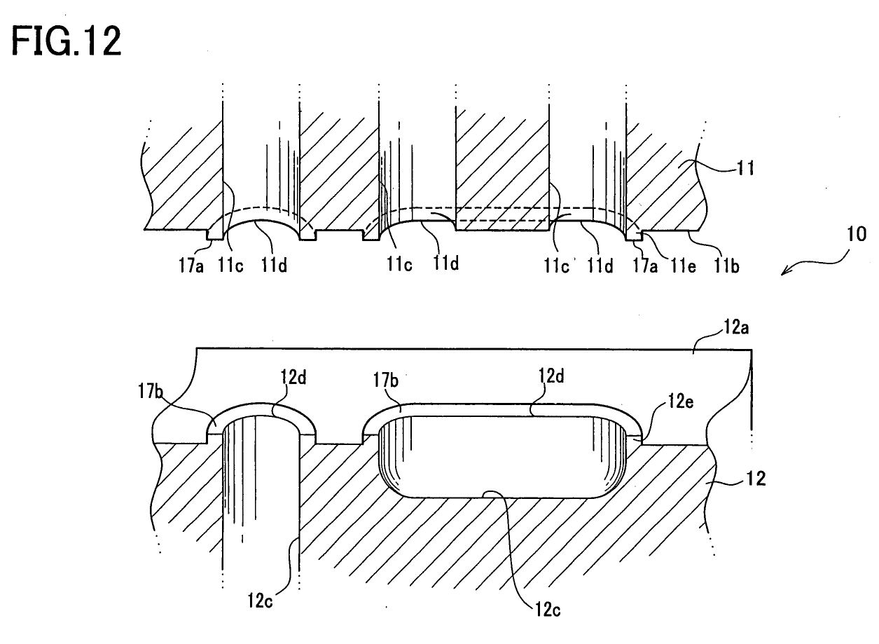

FIG. 12 is an exploded perspective partial view of the first and second block members 11 and 12 to be assembled to constitute the passage block 10 in the second embodiment. The lower surface 11b of the first block member 11 is formed with a first coupling protrusion 11e whose end face provides the first passage-end contact portion 17a.

The upper surface 12a of the second block member 12 is formed with a second coupling protrusion 12e whose end face provides the second passage-end contact portion 17b.

In the second embodiment, without using the gasket 18 of the first embodiment, the first and second block members 11 and 12 are provided with the first and second coupling protrusions 11e and 12e which are placed in contact with each other, and the first and second passage-end contact portions 17a and 17b which are contact surfaces of the protrusions 11e and 12e are diffusion-bonded to each other.

The second embodiment configured as above can exhibit the following operations and advantages.

A first advantage is a reduction in the number of components as compared with the first embodiment, because the first block member 11 and the second block member 12 are placed in direct contact with each other for diffusion bonding.

Although the first embodiment uses the gasket 18 in the bonding portion, the second embodiment provides the first and second coupling protrusions 11e and 12e, thus eliminating the need for the gasket 18 to perform diffusion bonding. Accordingly, a reduction in the number of components can be achieved, contributing to cost reduction. This reduction in the number of components also leads to a decrease in assembling steps as well as a reduction in manufacturing cost of the gasket 18. Thus, a large cost reduction effect can be achieved.

In the second embodiment, the need for the retainer 20 used for holding the gasket 18 in the first embodiment can be eliminated. In the first embodiment, the retainer 20 is finally removed after used as a positioning jig and therefore can be used repeatedly several times. However, the retainer 20 is costly in manufacture and maintenance. Thus, the configuration of the second embodiment can provide a large advantage in cost because of nonuse of the retainer 20.

However, instead of not using the gasket 18, the first and second block members 11 and 12 have to be provided with the first and second coupling protrusions 11e and 12e respectively, which lead to a slight increase in machining cost of the first and second block members 11 and 12.

A second advantage is a reduction in the number of interfaces to be diffusion-bonded to each other, which may lead to a reduction in defective fraction.

To achieve good diffusion bonding as mentioned above, the first and second passage-end contact portions 17a and 17b have to be placed in close contact with each other without gaps. However, the number of such contact surfaces is half that in the first embodiment, because of the nonuse of gasket. Accordingly, portions required to be diffusion-bonded are also reduced and thus a decrease in defective fraction can be expected.

### Third Embodiment

A third embodiment is substantially the same in configuration as the first embodiment excepting the configurations of the first and second coupling-face apertures 11d and 12d. The following explanation is thus made with a focus on the differences.

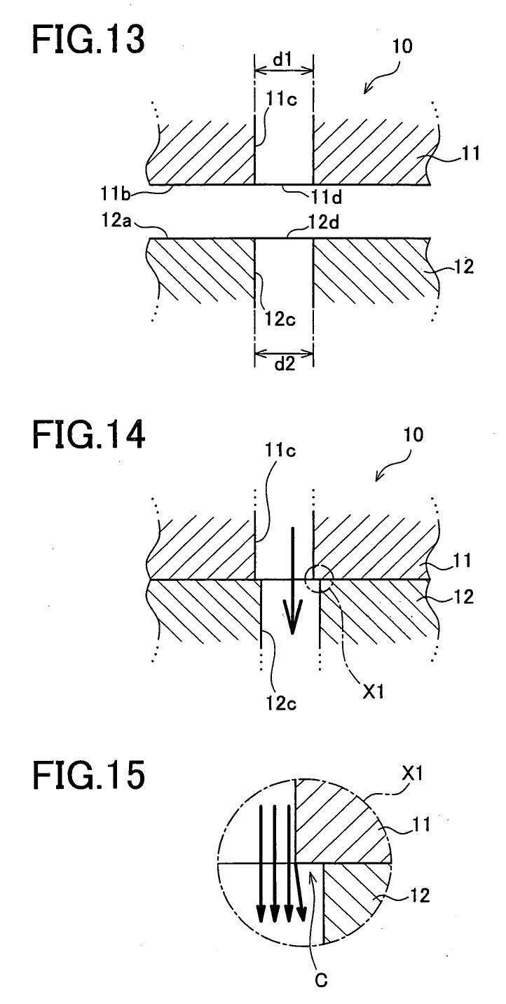

FIGS. 13 to 15 are partial sectional views showing a state where displacement occurs when the first-coupling-face aperture 11d and the second-coupling-face aperture 12d are equal in area. Specifically, FIG. 13 shows a state before the first-block lower surface 11b and the second-block upper surface 12a are placed in contact with each other. FIG. 14 shows a state where the lower surface 11b and the upper surface 12a are placed in contact with each other. FIG. 15 shows an enlarged view of part X1 in FIG. 14.

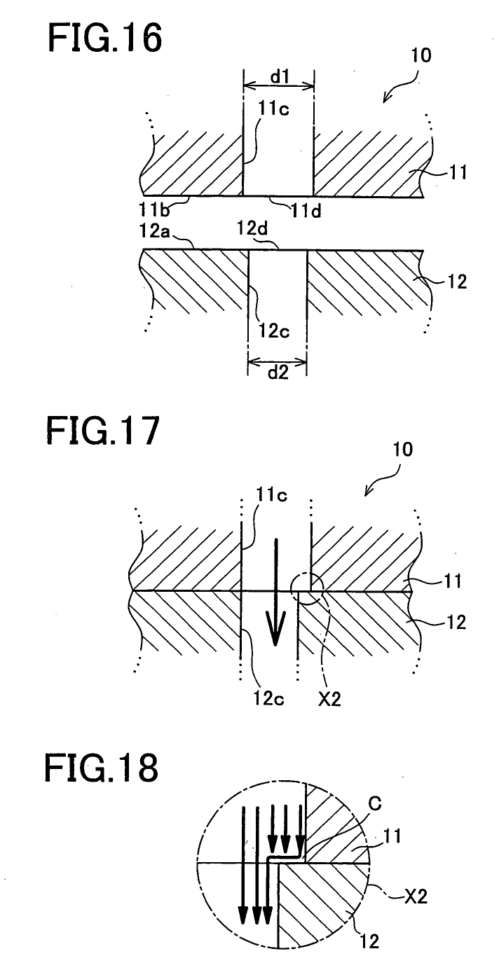

FIGS. 16 to 18 are views in which the first-coupling-face aperture 11d and the second-coupling-face aperture 12d are bonded in the third embodiment. Specifically, FIG. 16 shows a state before the first-block lower surface 11b and the second-block upper surface 12a are placed in contact with each other. FIG. 17 shows a state where the lower surface 11b and the upper surface 12a are placed in contact with each other. FIG. 18 shows an enlarged view of part X2 in FIG. 17.

The first-coupling-face aperture 11d provided in the first block member 11 of the third embodiment is designed to have a diameter “d1”. On the other hand, the second-coupling-face aperture 12d provided in the second block member 12 is designed to have a diameter “d2”. The first diameter d1 is larger than the second diameter d2 with a difference determined including assembly tolerance and dimensional tolerance for manufacture.

The gasket 18 is not used in the third embodiment, but it may be adopted. Alternatively, the first and second block members 11 and 12 may be provided with the first and second coupling protrusions 11e and 12e on the first-block lower surface 11b and the second-block upper surface 12a respectively.

The third embodiment configured as above can exhibit the following operations and advantages.

In the case where the first aperture diameter d1 is equal to the second aperture diameter d2, a shoulder portion C is apt to occur as shown in FIGS. 13 to 15. Such shoulder portion C is inevitably produced in view of product's dimensional tolerance and assembly tolerance.

When a shoulder portion C is produced as if causing a dead space behind the first-block lower surface 11b when viewed from upstream of the flow of fluid, as shown in FIG. 15, the fluid is likely to stagnate in the dead space. In the case where a fluid tending to crystallize allowed to flow through the passage block 10, the fluid may crystallize in such stagnation region. The straight passages 10b and U-shaped passages 10c of the passage block 10 are regularly purged with inert gas. However, if the stagnation region exists in the passage, this passage is hard to sufficiently purge. Thus, the crystallized gas could not be cleaned out.

However, in the configuration of the third embodiment in which the first aperture diameter d1 is larger than the second aperture diameter d2, as shown in FIG. 17, the shoulder portion C is produced, exposing the second-block upper surface 12a when viewed from upstream even where the first and second block members 11 and 12 are assembled with a displacement. Accordingly, the shoulder portion C is always subjected to the fluid flowing from the upstream side and therefore is unlikely to crystallize. The fluid does not stagnate even during purging, so that fluid replacement can be achieved reliably.

With the above configuration that the second aperture diameter d2 on the downstream side is smaller than the first aperture diameter d1 on the upstream side, no stagnation region is produced in the passage and fluid replacement can be easily performed. Even when the fluid tending to crystallize is used, crystallization can be prevented.

### Fourth Embodiment

A fourth embodiment is substantially the same in configuration as the first embodiment excepting the inner shape of the gasket 18. The following explanation is thus made with a focus on the differences.

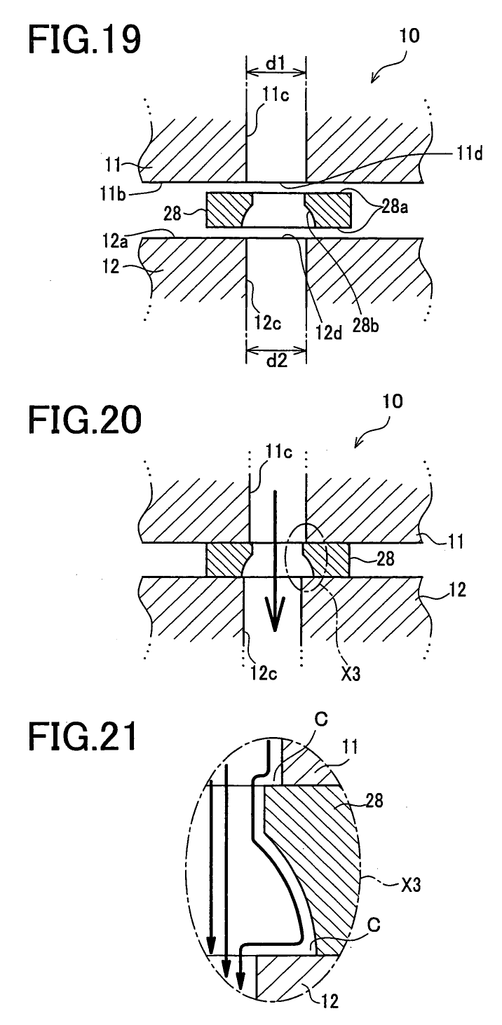

FIGS. 19 to 21 show a state for bonding the first and second block members 11 and 12 by use of a gasket 28 of the fourth embodiment. Specifically, FIG. 19 shows a state before the first block member 11, second block member 12, and gasket 28 are placed in contact with each other. FIG. 20 shows a state where the first block member 11, second block member 12, and gasket 28 are placed in contact with each other. FIG. 20 is an enlarged view of a portion X3 in FIG. 20.

The gasket 28 of the fourth embodiment is designed so that an aperture of an end face 28a on an upstream side facing the first-block lower surface 11b has a diameter smaller than the first diameter d1 of the first-coupling-face aperture 11d and an aperture of an end face 28a on a downstream side facing the second-block upper surface 12a has a diameter larger than the second diameter d2 of the second-coupling-face aperture 12d. The gasket 28 is formed with an inner passage 28b defined by a curved wall continuous from the upstream-side aperture to the downstream-side aperture. To be precise, the gasket 28 is machined from bottom, or the downstream side, to form a passage spherically expanding from the upstream-side aperture to the downstream-side aperture.

The passage block 10 of the fourth embodiment configured as above can exhibit the following operations and advantages.

The fourth embodiment provides the configuration using the gasket 28 so as to achieve the same advantages as in the third embodiment. To be more specific, the diameter of the upstream-side aperture of the gasket 28 is smaller than the first diameter d1 of the first-coupling-face aperture 11d and the diameter of the downstream-side aperture of the gasket 28 is larger than the second diameter d2 of the second-coupling-face aperture 12d, thereby preventing the shoulder portion C from becoming a fluid stagnation region.

This makes it possible to prevent the fluid from stagnating in the passage of the passage block 10 and facilitating fluid replacement to change the fluid to another to be allowed to flow in the passage. Further, even if the fluid tends to crystallize, it is possible to prevent crystallization by regular purging of the shoulder portion C.

### Fifth Embodiment

A fifth embodiment is substantially the same in configuration as the first embodiment excepting the bonding of additional block members to the first and second block members 11 and 12 and the same in the shape of a gasket.

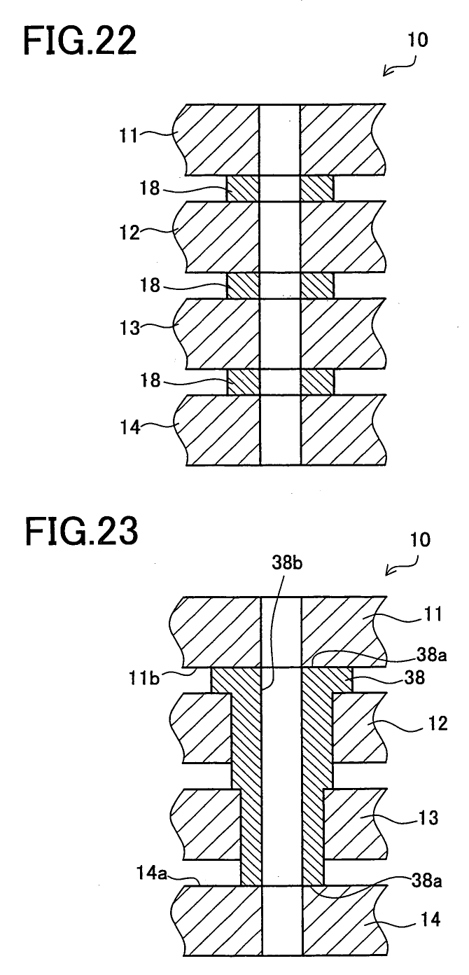

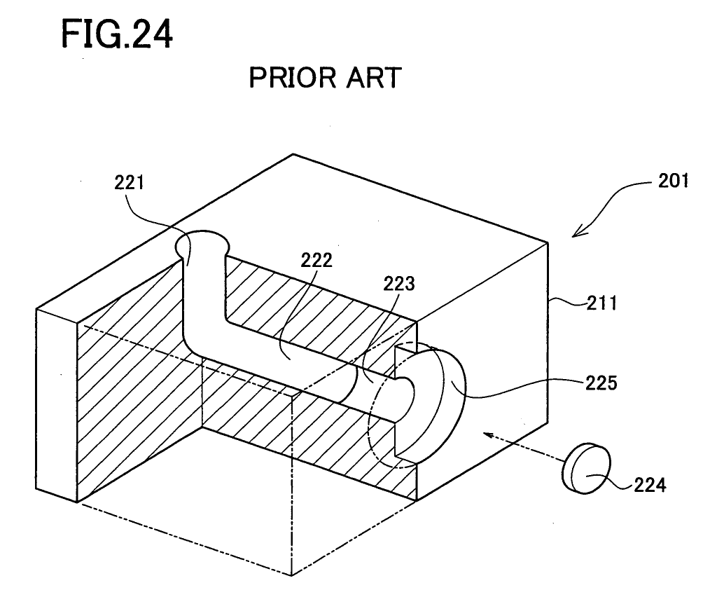

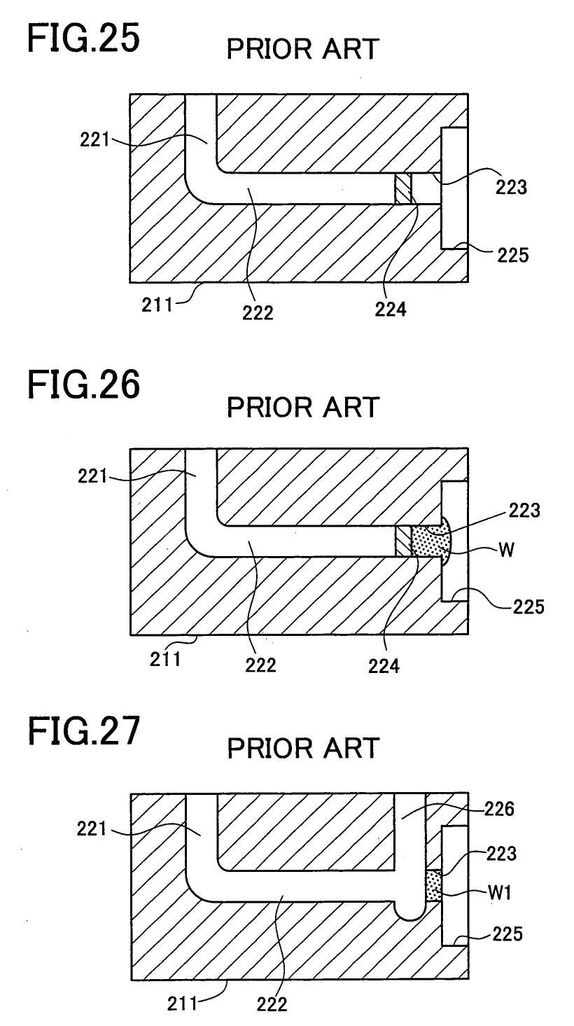

FIG. 22 is a sectional view of the passage block 10 composed of a plurality of block members, which are bonded through the gaskets 18 of the first embodiment. FIG. 23 is a sectional view of the passage block 10 composed of the plurality of block members, which are bonded through a gasket 38 of the fifth embodiment.

The passage block 10 of the fifth embodiment includes a third block member 13 and a fourth block member 14 in addition to the first block member 11 and the second block member 12. Those first to fourth block members are bonded to one another.

The gasket 38 used in this embodiment is of a stepped cylindrical shape as shown in FIG. 23. This gasket 38 is configured as to pass through the second block member 12 and the third block member 13 and abut on the first block member 11 and the fourth block member 14 respectively. The second block member 12 and the third block member 13 are formed with through holes engageable with the outer surfaces of the gasket 38.

The passage block 10 of the fifth embodiment configured as above can exhibit the following operations and advantages.

In the case where the passage block 10 is composed of a plurality of block members bonded to one another, such as the first to fourth block members 11 to 14, the gaskets 18 have to be interposed between them, increasing the number of diffusion-bonding faces between the passage-end contact portions such as the first passage-end contact portion 17a and the gasket end faces 38a. This may increase the possibility of causing fluid leakage due to bonding failure.

Since the gasket 38 is configured so as to abut on the surfaces of the first and fourth block members 11 and 14 respectively as shown in FIG. 23, the portions needing to be diffusion-bonded can be decreased, thus restraining the possibility of causing fluid leakage due to bonding failure and also cutting out the need for processing. The bonding areas of the gasket end faces 38a and the passage-end contact portions of the first and fourth block members 11 and 14 have to be subjected to the lap-grinding or the like so that those surfaces are bonded in close contact with each other without leaving gaps therebetween. Since the gasket inner passage 38b forms a passage of the second and third block members 12 and 13, the portions of the second and third block members 12 and 13 contacting with the gasket 38 have only to be processed to the extent to ensure engagement accuracy.

Consequently, processing cost can be reduced and the possibility of causing fluid leakage due to bonding failure can be decreased. Further, a cost reduction effect in association with a reduction in the number of components can be expected.

The above configuration is not always available for all the passages formed in the passage block 10. It is however considered costly advantageous that the above gasket 38 is diffusion-bonded between the block members to form parts of the passages.

The present invention, which is explained in the above embodiments, may be embodied in other specific forms without departing from the essential characteristics thereof.

For instance, the shape of passages shown in the first to fifth embodiments and the patterns are merely examples. Any passage configurations required in design can be provided without limitations.

Any combinations of the first to fifth embodiments may be adopted.

The materials exemplified in the first to fifth embodiments may be replaced with other materials.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A passage block connectable to a fluid control device for controlling a fluid, the passage block being formed with a passage connectable to the fluid control device, the passage block comprising:
a first block member including a first coupling face and a plurality of first-coupling-face apertures opening in the first coupling face;
a second block member including a second coupling face and a plurality of second-coupling-face apertures opening in the second coupling face in correspondence with the first-coupling-face apertures;
a passage-end contact section including:
a first passage-end contact portion formed around each of the first-coupling-face apertures; and
a second passage-end contact portion formed around each of the second-coupling-face apertures;
the passage-end contact portion being provided in such a manner that the first coupling face of the first block member and the second coupling face of the second block member are arranged to face each other so that the first passage-end contact portion and the second passage-end contact portion contact with each other, the first and second block members are heated under pressure in a direction perpendicular to the first and second coupling faces to diffusion-bond the first and second passage-end contact portions to each other.

2. The passage block according to claim 1, further comprising:
a first coupling protrusion formed to protrude from the first coupling face around the first-coupling-face aperture and include the first passage-end contact portion; and
a second coupling protrusion formed to protrude from the second coupling face around the second-coupling-face aperture and include the second passage-end contact portion.

3. The passage block according to claim 1, wherein one of the first-coupling-face aperture and the second-coupling-face aperture is on the upstream side and the other is on the downstream side, and the aperture area on the downstream side is smaller than that on the upstream side.

4. The passage block according to claim 2, wherein one of the first-coupling-face aperture and the second-coupling-face aperture is on the upstream side and the other is on the downstream side, and the aperture area on the downstream side is smaller than that on the upstream side.

5. The passage block according to claim 1 further comprising a gasket interposed between the first and second block members to couple the first-coupling-face aperture and the second-coupling-face aperture, and
wherein the first passage-end contact portion and the second passage-end contact portion are placed in contact with the gasket respectively and diffusion-bonded to each other to form the passage-end contact section.

6. The passage block according to claim 5, wherein the gasket is formed with an inner passage that has an aperture area on an upstream side being smaller than an aperture area on a downstream side.

7. A method of manufacturing a passage block connectable to a fluid control device for controlling a fluid, the passage block being formed with a passage connectable to the fluid control device, the method comprising the steps of:
arranging a first block member including a first coupling face and a plurality of first-coupling-face apertures opening in the first coupling face and a second block member including a second coupling face and a plurality of second-coupling-face apertures opening in the second coupling face in correspondence with the first-coupling-face apertures so that a first passage-end contact portion formed around each of the first-coupling-face apertures is placed in contact with a second passage-end contact portion formed around each of the second-coupling-face apertures;
pressing the first and second block members by use of a block pressure device; and
heating the first and second block members by use of a heating device to diffusion bond the first passage-end contact portion and the second passage-end contact portion to form the passage.

8. The method of manufacturing the passage block, according to claim 7, further comprising the steps of:
interposing a gasket between the first block member and the second block member to couple the first-coupling-face aperture and the second-coupling-face aperture; and
positioning the gasket in place by use of a gasket holding member for holding the gasket so that the gasket is diffusion-bonded to the first and second block members.
